(19) United States
(12) Patent Application Publication
(10) Pub. No.: US 2006/0236543 A1
(43) Pub. Date: Oct. 26, 2006

(54) Rotating member of a printing press comprising a bale

(76) Inventors: Wolfgang Robert Josef Felgenhauer, Gemunden (DE); Eckhard Hermann Carsten, Würzburg (DE)

Correspondence Address: Douglas R Hanson;Jones Tullar & Cooper, Eads Station, PO Box 2266, Arlington, VA, 22202, US

(21) Appl. No.: 10/533,292

(22) PCT Filed: Oct. 23, 2003
(86) PCT No.: PCT/DE03/03528

§ 371 Date: May 2, 2006

(30) Foreign Application Priority Data
Oct. 31, 2002 (DE) 102 50 690.6

(51) Int. Cl. B23P 17/00

(52) U.S. Cl. 29/895.2

(57) ABSTRACT

A rotating member of a printing press is comprised of a barrel that includes a base body having a cylindrical surface, and at least one outer element that is applied to the surface of the base body. The outer element has at least one hollow space through which a heat exchange fluid can flow. Alternatively, the outer element may cover a hollow space in the base body which preferably carries the heat exchange fluid. The outer element does not hinder access to a plate end clamping channel that is situated in the base body.

### CROSS-REFERENCE TO RELATED APPLICATIONS

This patent application is the U.S. national phase, under 35 U.S.C. 371, of PCT/DE 2003/003528, filed Oct. 23, 2003; published as WO 2004/039589 A1 on May 13, 2004, and claiming priority to DE 102 50 690.6, filed Oct. 31, 2002, the disclosures of which are expressly incorporated herein by reference.

### FIELD OF THE INVENTION

The present invention is directed to a rotating body, with a barrel, of a printing press. The rotating body has a cylindrical surface on its barrel and has an outer body. The outer body contacts, and is spaced from the cylindrical surface.

### BACKGROUND OF THE INVENTION

Cylinders of a printing group, which are embodied as hollow bodies, are known from DE 41 19 824 C1 and DE 41 19 825 C1. The cylinder consists of a one-piece cast body forming an outer body and, if required, additionally has an inner one-piece rotationally-symmetrical cast body. Both of the cast bodies consist, for example, of cast steel or gray cast iron and, in the case of DE 41 19 824 C1, are made to be one piece by the use of connecting strips, or they are welded together.

A cylinder of a printing group made of gray cast iron is known from DE 42 12 790 A1. To increase the cylinders flexural strength, an axially extending steel core has been cast centered in the cylinder. This steel core, at the same time, projects as a shaft journal from the faces of the cylinder. The gray cast cylinder encloses the steel core concentrically and has hollow spaces.

A cylinder of a printing group, which consists of a base body of gray cast iron or of cast light alloy, is known from DE 196 47 067 A1. A preferably hollow cylinder core is cast into the base body as a stiffening member. The cylinder core consists of, for example, a steel tube. Further profiled reinforcement elements, extending parallel with the axis of rotation of the cylinder and having a solid or a hollow cross section, possibly with an uneven wall thickness, are arranged in a radially outside located area of the base body, are distributed over the circumference of this area, and preferably have been brought as closely as possible to the shell face of the base body. The stiffening member and all of the profiled reinforcement elements are closed at their respective ends and are completely enclosed by the cast material of the base body.

A double-shell cylinder, which can be temperature-regulated, is known from the patent documents DE 861 642 B and DE 929 830 B. A heating medium or a cooling medium, which preferably is air, is conducted over a helical course inside the double cylinder shell. The interior cylinder and the exterior cylinder are arranged at a radial distance of approximately 10 to 20 mm from each other.

A counter-pressure cylinder, which can be temperature-regulated, is known from DE 20 55 584 A. This cylinder has heating chambers inside its shell over the entire cylinder width, which heating chambers are connected to a warm water circuit by a feed line, that is arranged axially in a cylinder journal, and by a discharge line, which is conducted coaxially with respect to the feed line.

A printing forme cylinder, which can be temperature-regulated, is known from DE 37 26 820 A1. The interior of this cylinder is completely filled with a fluid. The fluid passes through a first circuit extending outside of the printing forme cylinder. A preferably coil-shaped cooling tube penetrates the fluid over the entire width of the cylinder. A cooling medium, flowing through the cooling tube, which is connected to a second circuit, cools the fluid and therefore also cools the cylinder.

A cylindrical rotating body for printing presses, which can be temperature-regulated by the introduction of water vapor, is known from DE 93 06 176 U1. Bores or lines are arranged extending underneath, and close to a shell face of the rotating body. The bores or lines can have a course which is different from being axially parallel, and therefore can drop, for example, towards the center of the rotating body.

A cylindrical rotating body for printing presses which can be temperature-regulated is known from DE 195 10 797 A1. A coolant flows, in only one circuit, through the entire interior of the body, and is equipped, on one side, with a coolant supply and a coolant removal device that is arranged in a cylinder journal and which is connected with a rotary transmission leadthrough.

A printing forme cylinder, which can be temperature-regulated, is known from DE 199 57 943 A1. The cylinder has cast core chambers in its interior, which chambers extend over the width of the cylinder and are closed off at the faces by covers. A tube, extending over the width of the cylinder, is arranged in each chamber. A sealingly displaceable tube unit, which is connected with a rotary transmission leadthrough for supplying and removing a coolant, has been inserted into each tube. Each tube is connected, via a radial bore, with the tube unit at the front of the cylinder which is equipped with the tube unit. Supplied coolant flows through the tubes and empties into the hollow cast core chambers in the area of the oppositely located front of the cylinder and from there is removed via a radial bore connected with the tube unit.

A cylinder for a rotary printing group, which can be temperature-controlled and which is embodied with approximately full walls, is known from EP 0 557 245 A1. This cylinder has a first line along its axis of rotation and, closely underneath its shell face, it has several lines, which are connected with the first line, which are preferably arranged at equal distances in the circumferential direction and which extend parallel with the axis of rotation. A fluid for regulating the temperature of the shell face can flow through these several lines.

A cylinder for a rotary printing group, which can be temperature-controlled, is known from EP 0 652 104 A1. A cylinder shell tube, at each end of which a flange is arranged, is provided. A separation tube and a supply tube extend in the interior of the cylinder coaxially with respect to its length. A hollow space between the separation tube and the cylinder shell tube forms a cooling chamber, through which cooling chamber, a coolant fed in by the supply tube flows. The line in the separation tube is connected with the cooling chamber via connecting bores in one of the flanges.

A cylinder for a rotary printing group, which can be temperature-controlled, is known from WO 01/26902 A1 and WO 01/26903 A1. A tube-shaped or a solid base cylinder body, is surrounded by a tube-shaped outer cylinder body. A conduit, through which temperature-control fluid can flow, is formed on the circumference of the base cylinder body, or in a gap between the base cylinder body and the outer cylinder body. The conduit can, for example, be embodied as an open gap with a circular profiled head space, or as a continuous groove extending helically in the axial direction of the cylinder.

A roller for printing presses is known from DE 28 53 594 C2. This roller has a cast base body of polyamide as the barrel, with a shaft arranged centered in it. A conduit for a temperature-regulation medium, which leads into the barrel, is provided in the shaft.

A forme cylinder of a flexographic printing press, with two half-shell-shaped saddle plates, which are screwed to the forme cylinder, is known from DE 84 36 119 U1. The end areas of flexographic printing plates are held on the forme cylinder at respective clamping strips which are arranged between the saddle plates. Each clamping strip is screwed to an insert strip that is attached to the forme cylinder.

A sheet guidance drum for sheet-fed rotary printing presses is known from DE 39 02 923 C2. A support plate, which is supported by several elastically acting carrier elements or supports, is arranged on a deflection drum. The carrier elements or supports are placed at an inclination with respect to the deflection drum. A radial height of the support plate, that is provided by the carrier elements or supports, can be adjusted, and in particular can be reduced, by the clamping of a shell foil resting on the support plate, which is directed in the circumferential direction of the deflection drum.

A rubber blanket cylinder for an offset printing press is known from DE 34 41 175 C2. A rubber blanket, which is clamped on the rubber blanket cylinder, extends over a recess that is provided as a relief device in the rubber blanket cylinder.

### SUMMARY OF THE INVENTION

The object of the present invention is directed to providing rotating bodies with a barrel of a printing press.

In accordance with the present invention, this object is attained by the provision of a rotating body of a printing press and having a barrel with a cylindrical surface. An outer body, whose outside constitutes the shell face of the barrel, is supported on the barrel. The outer body has at least one hollow interior space that is open toward the surface of the barrel or base body. A temperature-regulating medium flows through the hollow space. The outer body may include several curved segments each having an angle of less than 360°. A gap is defined by the non-continuous curved segments and forms an opening to a clamping channel.

The advantages to be attained by the present invention consist, in particular, in that a hollow space in the barrel of the rotating body can be produced in a simple manner. In connection with a preferred embodiment of the rotating body as a forme cylinder or as a transfer cylinder, if a temperature-regulation medium flows through the hollow space, access to a holding device, which is embodied in the barrel for holding a dressing arranged on the shell face, is not hampered. In this case, the rotating body, and in particular its barrel, can be produced in a simple manner, such as, for example, also by the use of casting technology. An exterior body, that is embodied in several parts, can be applied to the surface of the base body in a simple manner without it being necessary to exactly fit the base body and the exterior body together, such as, for example, by coaxially pushing them together. A shaft, which can be made of a high-strength material and that is introduced centered into the barrel or into its base body, permits the provision of a conduit of a large cross section for use in the inflow and outflow of the temperature-regulation medium. The throughput of a larger volume of flow is accomplished without having to increase the exterior dimensions of the rotating body for maintaining the same strength values. By the use of the proposed geometric configuration of the hollow spaces, which are used as flow conduits, it is possible to maintain the effect of the temperature-regulation medium approximately constant during its flow through the rotating body. A thermal insulation of the temperature-regulation medium against the base body is particularly advantageous for increasing the effectiveness of the heat exchange between the temperature-regulation medium and the exterior body.

### BRIEF DESCRIPTION OF DRAWINGS

Preferred embodiments of the present invention are represented in the drawings and will described in greater detail in what follows.

Shown are—in FIGS. 1 to 7 respectively in longitudinal and in cross section—in:

FIG. 1, a rotating body of a printing press in accordance with a first preferred embodiment of the present invention, with axially extending hollow bodies, in

FIG. 2, a rotating body of a printing press in accordance with a first preferred embodiment, with a hollow body extending in a helical line, in

FIG. 3, a rotating body of a printing press in accordance with a second preferred embodiment of the present invention, with an integrally cast body and having a conduit, in

FIG. 4, a rotating body of a printing press in accordance with a third preferred embodiment, with a base body and with a solid exterior body applied thereto, wherein hollow spaces which are open toward the base body have been cut into the exterior body, in

FIG. 5, a rotating body of a printing press in accordance with a variation of the third preferred embodiment, with a base body and a solid exterior body applied thereto, wherein hollow spaces which are covered by the exterior body have been cut into the base body, in

FIG. 6a, a rotating body of a printing press in accordance with a fourth preferred embodiment of the present invention, with a conduit formed between a base body and an exterior body, in

FIG. 6b, a rotating body of a printing press in accordance with the fourth preferred embodiment, with a conduit formed between a base body and an exterior body, in

FIG. 7, a rotating body of a printing press in accordance with a fifth preferred embodiment of the present invention, with a shaft made of a high-strength material introduced into the barrel, and in

FIG. 8, an embodiment of a hollow body or conduit of a rotating body with a temperature-regulated shell face, wherein the heat exchange between the shell face and a temperature-regulation medium is constant.

### DESCRIPTION OF THE PREFERRED EMBODIMENTS

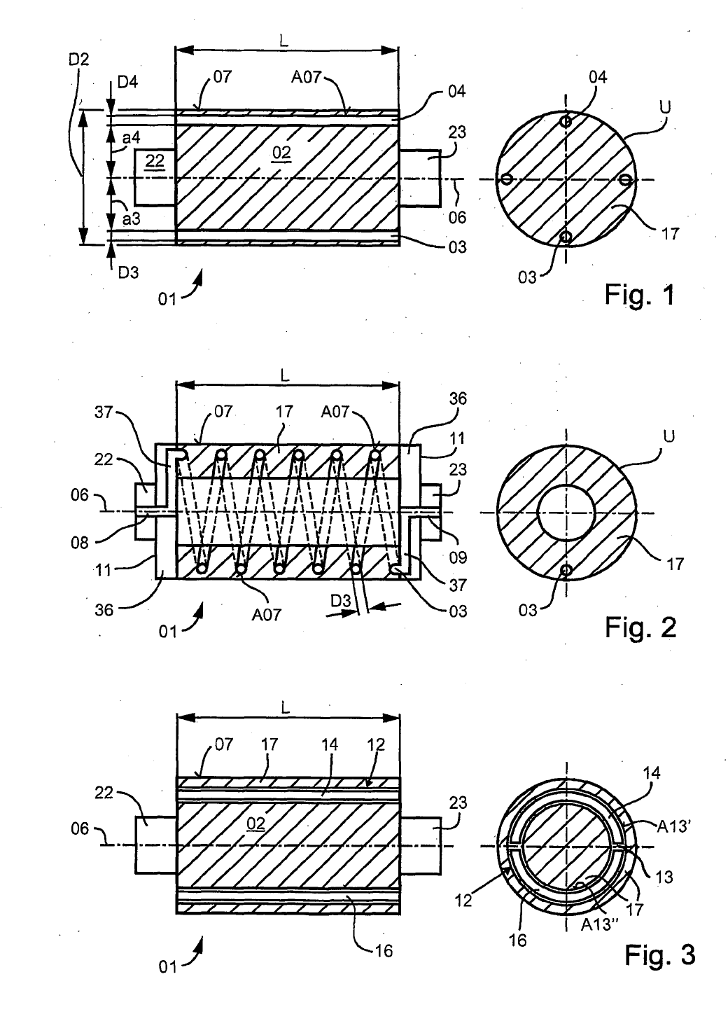

A first preferred embodiment of a rotating body 01 of a printing press, in accordance with the present invention, is shown in FIGS. 1 and 2. The rotating body 01 has a barrel 02, or a barrel 02 with a base body 17 in which at least the base body 17 is made of a casting material. The barrel 02, or its base body 17, has an axial length L, and has, in its outer area, i.e. in an area closely underneath a shell face 07, has at least one tube-shaped hollow body 03, 04 that is enclosed in the casting material forming the base body 17. The hollow body 03, 04 extends over the entire length L of the barrel 02, or its base body 17. As depicted in FIG. 1, the hollow body 03, 04 can extend, for example, parallel, with respect to a longitudinal axis 06 of the rotating body 01, or, as is represented in FIG. 2, it can pass through the outer area of the barrel 02, or its base body 17, in a helical line from one end face 11 to an oppositely located second end face 11. In the longitudinal section of FIG. 2, the helical-line-like course of the hollow body 03 has been drawn in dash-dotted lines. Regardless of its course, the hollow body 03, 04 forms a conduit, through which a temperature-regulation medium can flow. Such a flow medium is usable for regulating the temperature of at least the shell face 07 of the barrel 02. The temperature-regulation medium preferably is a fluid heat-conducting medium, such as water or an oil, for example.

To accomplish the introduction of, and the removal of the flow medium into or from the barrel 02, the hollow body 03 can be connected with lines 08, 09, which are attached at the end face or front side of, for example, the barrel 02, or which can be attached there on a flange 36 in the form of an annular groove 37, as seen in FIG. 2. Also, in the case of several hollow bodies 03, 04 that are arranged in the barrel 02, or in its base body 17, these allow bodies 03, 04, as well as the lines 08, 09 which are connected with them, can advantageously have a common connector on one of the ends or faces 11 of the barrel 02.

It is advantageous, for good temperature regulation, to arrange a contact face A07, which relevant to the heat exchange of the hollow body 03, 04 closely, i.e. if possible only a few millimeters, and preferably less than 20 mm, underneath the shell face 07 of the barrel 02. If several hollow bodies 03, 04 are arranged, spaced along the circumference U of the barrel 02, it is advantageous if the temperature-regulation medium flows in opposite directions through adjoining hollow bodies 03, 04. If several hollow bodies 03, 04 are provided in the outer area of the barrel 02, or in its base body 17, it is advantageous to arrange all of these hollow bodies 03, 04 at the same radial distance a3, a4 from a longitudinal axis 06 of the rotating body 01, as well as spaced at even distances in the direction of the circumference U of the barrel 02. This insures that as even a temperature regulation of the shell face 07 of the barrel 02 as possible can be achieved.

The hollow body 03, 04 in the rotating body 01 is produced by a casting technology and has a narrow interior diameter D3, D4. That interior diameter D3, D4 is preferably less than 25 mm, and in particular is between 15 mm and 20 mm. A conduit of such a narrow interior diameter D3, D4 can be produced only with difficulty by casting technology, by the insertion of a cast core into a barrel 02, or a base body 17, to be produced. For this reason, it has been attempted to drill such a conduit into the barrel 02 or its base body 17. However, over the length L of the barrel 02, or its base body 17, this drilling is expensive and is not without problems in its technical execution.

It is therefore proposed, in connection with the first embodiment of a rotating body 01, as depicted in FIG. 1, to place a tube-shaped hollow body 03, 04, or a hollow body 03, 04 that is embodied as a tube, and preferably as a steel tube, into a casting mold for the barrel 02, or for its base body 17, and to enclose the tube in the casting material. So that the tube-shaped hollow body 03, 04 does not become soft and thus is not deformed because of its being heated as a result of the effect of the temperature of the melted material of the barrel 02, or its base body 17, it is necessary to embody the hollow body 03, 04 with comparatively thick walls with respect to its interior diameter D3, D4. A wall thickness of the hollow body 03, 04 is preferably at least one-fifth of an interior diameter D3, D4. Thus, a suitable wall thickness of the tube-shaped hollow body 03, 04 preferably is at least 3 mm, and in particular is between 5 mm and 6 mm. Furthermore, the tube-shaped hollow body 03, 04 can also be fixed in place in the casting mold for the barrel 02, or for its base body 17, and can be stabilized by the use of support elements.

In accordance with FIG. 2, the barrel 02, or its base body 17, can be embodied as a hollow cylinder 02, into whose annular wall the tube-shaped hollow body 03, 04 is cast. The rotating body 01 can be employed in a printing press, which is not specifically depicted, as a roller in an inking system or in a dampening system or can be used, for example, as a cylinder 01 for use in conveying a material to be imprinted, or as a roller 01 for use in conveying a material to be imprinted.

If, for example, the rotating body 01 is embodied as a cylinder 01 of a printing group, this cylinder 01 can be configured, for example, as a forme cylinder 01 or as a transfer cylinder 01. Such a cylinder 01 can be covered, for example, with one dressing or with two dressings extending in the direction of its circumference U, and can be covered axially, i.e. over its length L, with up to, for example six dressings. In connection with use of the rotating body 01 as a forme cylinder 01, the dressings are primarily embodied as plate-shaped printing formes. In the case of a transfer cylinder 01, the dressings are preferably rubber printing blankets which are applied to a support plate. As a rule, a plate-shaped printing forme, or a support plate for a rubber printing blanket, consists of a flexible, but otherwise dimensionally stable material, such as, for example, an aluminum alloy.

The printing group, in which the previously mentioned cylinder 01 is employed, can be configured as a nine-cylinder satellite printing unit, for example, in which four printing pairs, each consisting of a forme cylinder 01 and of a transfer cylinder 01, are arranged around a common counter-pressure cylinder. At least the forme cylinders 01, for example, can each have the characteristics of the attainment of the object here proposed. Arrangements are advantageous, particularly for newspaper printing, in which a forme cylinder 01 is covered, in its axial direction, with up to six side-by-side plate-shaped printing forms, and is also covered along its circumference U either with one plate-shaped printing forme, or with two plate-shaped printing formes which are position one behind the other. Such a forme cylinder 01 rolls off on a transfer cylinder 01, which is axially covered with up to three side-by-side arranged rubber printing blankets, for example, and in which every rubber printing blanket covers the entire circumference U of the transfer cylinder 01. As a rule, the rubber printing blankets have twice the width and length of the plate-shaped printing formes that are used with the forme cylinder 01 which acts together with the transfer cylinder 01. The forme cylinder 01 and the transfer cylinder 01 preferably have the same geometric dimensions with regard to their axial length and their circumference U. For example, a rotating body 01, which is embodied as a cylinder 01, has a diameter D2 of, for example, 140 mm to 420 mm, and preferably of between 280 mm and 340 mm. The axial length of the barrel 02 of the cylinder lies, for example, in the range of between 500 mm and 2400 mm, and preferably lies between 1200 mm and 1700 mm.

The explanations provided here, with regard to the configuration and the employment of the proposed rotating bodies 01 should apply, in a corresponding manner, also to the embodiments which will be described hereinafter.

As is represented in FIG. 3, a second preferred embodiment of the rotating body 01 of a printing press, in accordance with the present invention, can provide that at least one body 12 is arranged in the barrel 02 of the rotating body 01, or at least in a base body 17, which is made of a castable material, of the barrel 02. At least in a sectional view taken transversely to the axial direction of the rotating body 01, the body 12 is delimited by two peripheral faces A13′, A13″, which peripheral faces are spaced apart from each other in the radial direction of the rotating body 01 and are closed in themselves. Both of the peripheral faces A13′, A13″ end with their sides facing away from the body 12 at the material of the barrel 02. At least one conduit 14, 16, which extends in the axial direction of the rotating body 01 and which is bordered by the material of the body 12, is formed in the interior 13 of the body 12.

In this embodiment, the body 12 can be embodied for example as a molded element which is produced by the use of casting technology, such as, for example, a pre-formed component, wherein the molded element has at least one hollow space in its interior 13 for forming the at least one conduit 14, 16. Alternatively, the body 12 can be a pressed or a continuously cast product, for example. The body 12 consists of a solid material, wherein a hollow space is formed in this body, preferably near its peripheral face A13′ that is oriented toward the shell face 07 of the barrel 02. The hollow space is delimited by the material of the body 12, at least in the longitudinal direction of the latter. Preferably, the body 12 is homogeneous and is embodied to be of one piece, or alternatively of several pieces, in the direction of the circumference U of the rotating body 01.

Advantageously, the body 12 is made of a heat-resistant material, such as, for example, of a ceramic material or of a reinforced metal foam. Heat resistance is required so that the body 12 does not become deformed when it is surrounded by the molten material of the barrel 02 which is used for producing the rotating body 01. A placement of the body 12, which placement is simple with regard to production technology, into the barrel 02 of the rotating body 01 results, if at least the barrel 02, or its base body 17, consists of a casting material of, for example, metal, ceramic, glass or plastic, and the body 12 is cast into the barrel 02, or its base body 17, and is enclosed by the casting material. During the manufacturing process of the rotating body 01, the body 12 can be placed, for this purpose, into the casting mold for casting the body 02, preferably in the outer area of the barrel 02, and can be fixed in place, if needed, with the aid of support elements, and cast in. The result is that the body 12 is completely enclosed by the casting material of the barrel 02. With an annular embodiment of the body 12, the space it encloses is preferably filled with the casting material of the barrel 02, so that at least the body 12 is enclosed by the casting material.

Since a temperature-regulation medium can flow through the conduit 14, 16 in the interior 13 of the body 12, in order to regulate the temperature of at least a partial area of the shell face 07 of the barrel 02, the body 12 is advantageously arranged in an outer area of the barrel 02. If the temperature of the entire shell face 07 of the barrel 02 is to be regulated, the conduit 14, 16 of the body 12 advantageously extends over the entire length L of the barrel 02. The temperature of at least that partial area of the shell face 07 of the barrel 02 is to be regulated, which partial area corresponds to the area on the shell face 07 of the barrel 02 to be imprinted. As in the first preferred embodiment, the rotating body 01 can again be a cylinder 01 which is conveying a material to be imprinted, or can be a roller 01 that is conveying a material to be imprinted.

A further advantageous embodiment of the body 12 consists in configuring it in a cylindrical shape, and to preferably match the length of the body 12 to the length L of the barrel 02. Therefore, the body 12 preferably has the shape of a hollow cylinder, in which the space enclosed by body 12 can be filled with the material of the barrel 02. In this case, the body 12 preferably encloses the longitudinal axis 06 of the rotating body 01. The conduits 14, 16, extending in the axial direction of the rotating body 01, can extend, in a manner that is similar to the example represented in FIGS. 1 and 2, parallel in relation to the longitudinal axis 06 of the rotating body 01, or can also extend helically in the outer areas of the barrel 02, or of the base body 17. If several conduits 14, 16 are provided in the body 12, the temperature-regulation medium can flow in opposite directions through adjoining ones of these conduits 14, 16.

In the two preferred embodiments of the rotating body 01 which have been described so far, it has been assumed, for the sake of simplicity, and without limiting the invention, that the rotating body 01 is homogeneously embodied, in other words, that the barrel 02 does not have a layered construction which extends concentrically to the shell face 07. Otherwise, a distinction would always have to be made between the barrel 02 and its base body 17, wherein the base body 17, and an outer body 19 enclosing it, would concentrically constitute the barrel 02. Thus, the description is intended to apply to both embodiments.

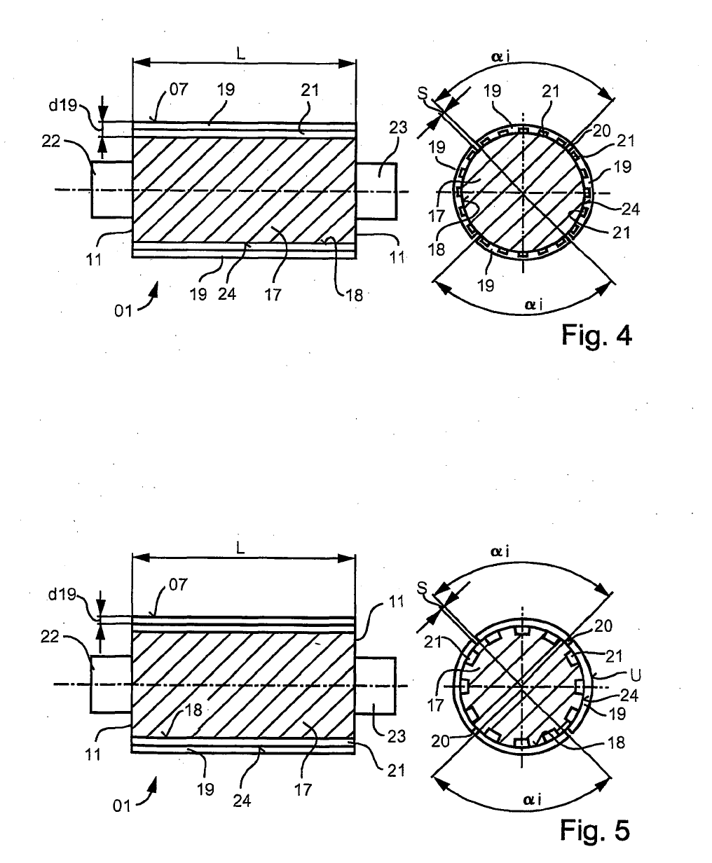

FIG. 4 shows a third preferred embodiment of the rotating body 01 of a printing press in accordance with the present invention. The barrel 02 of this rotating body 01 consists of at least a base body 17 with a cylindrical surface 18. At least one outer body 19 is applied to the surface 18 of the base body 17. The outer body 19 preferably consists of at least one curved piece, whose associated central angle α is less than 360°. In particular, with a rotating body 01 which is embodied as a forme cylinder 01 or as a transfer cylinder 01, the outer body 19, in its cross section, does not form a closed ring, but has at least one gap 20 which gap 20, for example in connection with a holding device that is not represented in FIG. 4, can be used for holding dressings which are applied to the rotating body 01. In connection with rollers which are not to be covered by a dressing, however, the outer body 19 can be configured as a closed ring, which closed ring encloses the base body 17 and is connected with the surface 18 of the latter. As an alternative to the above mentioned embodiment, it is also possible to apply several outer bodies 19 on the surface 18 of the base body 17. In this alternative, the outer bodies 19 are arranged on the surface 18 of the base body 17 in the direction of the circumference U of the base body 17. In the latter case, each such outer body 19 consists of a curved piece, wherein the central angles αi, in which i is a counting index for the curved pieces, belonging to the curved pieces complement each other to at most 360°. It is possible, in particular, to arrange two curved pieces symmetrically with respect to each other on the circumference U of the base body 17, wherein the central angle αi, in which i again is a counting index for the curved pieces, of each curved piece preferably is a little less than 180°. Thus, curved pieces of the outer body 19 can be provided, for example, in the form of half shells or of quarter shells. A gap 20 between the individual curved pieces of the outer body 19 can be a slit-shaped opening directed toward a clamping channel, with the previously mentioned holding device, for example, arranged in the base body 17. The gap 20 can have a gap width of, for example, less than 3 mm, and preferably of 1 mm to 2 mm. In both cases of the previously mentioned embodiment, as seen in FIG. 4, at least one hollow space 21 is provided in the outer body 19, and wherein the hollow space 21 is open in the direction toward the surface 18 of the hollow body 17. The outer body 19 constitutes the outer component of the barrel 02. An outer surface of the outer body 19, and constituting the shell face, can be covered with one or with two dressings. The dressing or dressings are respectively held in place on the rotating body 01 by use of the holding device which is formed in the barrel 02, and in particular in its base body 17, in a clamping channel. If the outer body 19 is configured in several parts, and preferably is configured in at least two curved pieces with a central angle αi, wherein i is a counting index for the curved pieces, of at most 180°, in the manufacture of the rotating body 01, the advantage is obtained that the base body 17 does not need to be inserted with an exact fit into the outer body 19. Instead the curved pieces can be applied to the surface 18 of the base body 17 by the use of a suitable releasable or a non-releasable connecting technique, such as, for example, by screwing or welding.

As can be seen in FIG. 5, the rotating body 01 can also be configured in such a way that its barrel 02 consists, at least, of a base body 17 with a cylindrical surface 18. A hollow space 21, which is open toward the surface 18 of the base body 17, is provided in the base body 17. An outer body 19, which is applied to the surface 18 of the base body 17, covers the hollow space 21. The outer body 19 consists of a curved piece, whose associated central angle α is less than 360°. It is alternatively possible, in this variation, for the barrel 02 of the rotating body 01 to consist of at least a base body 17 with a cylindrical surface 18. Several hollow spaces 21, which are open toward the surface 18 of the base body 17, are provided in the base body 17. Several outer bodies 19 are arranged on the surface 18 of the base body 17 in the direction of the circumference U of the base body 17, and the outer bodies 19, which are applied to the surface 18 of the base body 17, cover the respective hollow spaces 21. In the latter case, every outer body 19 consists of a curved piece, wherein the central angles αi, again where i is a counting index for the curved pieces, belonging to the curved pieces complement each other to at most 360°.

In connection with a rotating body 01 in accordance with the third preferred embodiment, as seen in, FIGS. 4 and 5, namely a rotating body 01 consisting of a base body 17 with a solid outer body 19, which, in particular, is embodied to not be compressible and which has a constant radial thickness d19, applied to the base body 17, the outer body 19 can be glued, welded or screwed, for example, to the surface 18 of the base body 18. In accordance with this third preferred embodiment, the outer body 19 can be applied either permanently or releasably to the surface 18 of the base body 17. Particularly suitable as welding methods are electron beam welding methods or laser beam welding methods. In this case, it may be sufficient, for fastening the outer body 19 on the base body 17, if the outer body 19 is incorporated into the material or is positively connected, in the above-mentioned way, with the surface 18 of the base body 17 only at the faces 11 of the barrel 02. A weld seam, for example, thus need not extend over the entire length L of the rotating body 01, but instead is provided only at some points, or is formed at several short sections of only a few millimeters length and spaced-apart from each other. The welded sections can be, for example, 5 mm to 25 mm long, and are preferably approximately 10 mm long, and are repeated at distances of 20 mm to 50 mm, and preferably at distances of 30 mm to 40 mm, in the axial direction of the rotating body.

The rotating body 01 can be configured in such a way that at least the base body 17, possibly together with journals 22, 23 which are intended for seating body 01, and which are formed at the end faces 11 of the barrel 02, and a drive mechanism of the rotating body 01, is forged, or that at least the outer body 19 is made of steel. In connection with the preferred embodiments of the present invention, it is provided that a temperature-regulation medium, for use in regulating the temperature of the shell face 07 of the barrel 02, flows through the hollow space 21, which, for example, can be cut by milling into the base body 17 or into an inside 24 of the outer body 19. In this way, the hollow space 21 constitutes a conduit 21 for the temperature-regulation medium. The hollow space 21 is arranged in the barrel 02 in such a way that the access of beveled ends of dressings, to be arranged on the shell face 07 of the barrel 02, to a clamping channel, which is arranged in the customary manner in the base body 17, is not interfered with. A slit-shaped opening, of a slit width S of less than 3 mm on the shell face 07 of the barrel 02, and extending radially with respect to the rotating body 01, is sufficient for this access. The base body 17 and the outer body 19 are put together in such a way that they seal the hollow space 21. The hollow space 21 can be oriented axially with respect to the barrel 02, or it can extend in a meander-like shape along the length L of the barrel 02. If several such hollow spaces 21 are provided, it is advantageous to arrange them at equal distances about the circumference U of the barrel 02. As in the previously described embodiments, the rotating body 01 can be a cylinder 01 which conveys a material to be imprinted, or it can be a roller 01 conveying a material to be imprinted.

A variation of the third preferred embodiment, as shown in FIG. 4, however without the gap 20 in the outer body 19, relates to a rotating body 01 of a printing press, having a barrel 02. The barrel 02 has at least a base body 17 with a cylindrical surface 18 and an outer body 19 which completely surrounds the surface 18 of the base body 17. The rotating body 01 is distinguished in that on its inside 24 it has at least one conduit 21 which is open toward the surface 18 of the base body 17. In this case, the outer body 19 preferably rests on the surface 18 of the base body 17. The outer body 19 and the base body 17 can be placed on each other by the use of a press fit, for example. In connection with this embodiment, and with a ring-shaped outer body 19, which is closed in itself, it is possible, depending on the requirements, to cut a gap 20 and an associated clamping channel, or to cut several gaps 20 and several associated clamping channels, into the rotating body 01, preferably at a location where no conduit 21 is formed in the outer body 19, such as, for example, by a milling operation, following the application and the fastening of the outer body 19 on or to the surface 18 of the base body 17. The gap 20 need not extend over the entire length L of the barrel 02. Instead, it can extend over only a portion of the length L of the barrel 02, so that the outer body 19 remains free of gaps, and therefore is continuous, at least at the faces 11 of the barrel 02.

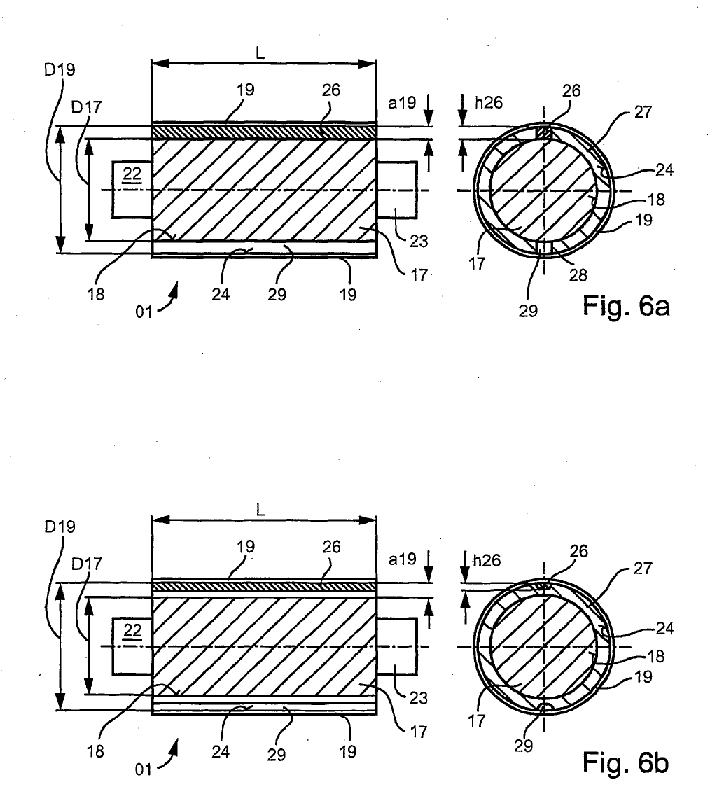

With respect to a fourth preferred embodiment of the rotating body 01 in accordance with the present invention, it is intended to first explain its manufacturing process. As can be seen in FIGS. 6a and 6b, this manufacturing process starts with a rotating body 01 of a printing press, having a barrel 02. The barrel 02 has at least a base body 17 with a cylindrical surface 18, and an outer body 19, which can surround the surface 18 of the base body 17 at a distance a19. The manufacturing process is distinguished in that at least one strip 26, that is made of a material which can be liquefied by heating, is attached to the inside 24 of the outer body 19 or on the surface 18 of the base body 17. Thereafter, the outer body 19 and the base body 17 are assembled coaxially covering each other by preferably being pushed on top of each other. A casting material, which can harden, is then cast into a hollow space 27 remaining between the base body 17 and the outer body 19, namely at a location where there is no strip 26. After the casting material has hardened, at least the outer body 19 is heated in such a way that the material of the strip 26 is liquefied and is thereby removed from the space 27 between the base body 17 and the outer body 19. The material of the strip 26 can be a plastic material or wax, for example. Synthetic resin, preferably a two-component synthetic resin, which, for example, sets at room temperature or at a temperature of up to 100° C. and hardens, is suitable for use as the casting material for filling the space 27 between the base body 17 and the outer body 19. The melting point of the casting material, which can lie, for example, at approximately 350° C., must, in any case, be higher than a melting point of the material of the strip 26, which can lie, for example, at 150° C. In this way, it is provided that the outer body 19 is solidly connected with the base body 17 by the casting material, such as the resin, introduced into the space 27 between the base body 17 and the outer body 19. However, an aluminum foam which sets can also be used as an alternative to resin for filling the space 27.

After the at least one strip 26, which was arranged between the base body 17 and the outer body 19, has been removed, preferably thermally, the casting material adjoining the previous strip 26, after it has solidified or set, forms a guide face 28 of a conduit 29. The casting material that was placed into the space 27 seals the resulting conduit 29 along its guide face 28 toward the base body 17 and toward the outer body 19. The strip 26 can extend over the length L of the barrel 02, preferably in its outer area, for example also helically. A radial extension of the strip 26 or its height h26, can be as large as a distance a19 between the base body 17 and the outer body 19, as seen in FIG. 6a. However, the height h26 of the strip 26 is preferably made to be less than the distance a19 between the base body 17 and the outer body 19, as seen in FIG. 6b, so that the casting material forms a bottom on the surface 18 of the base body 17 when the space 27 between the base body 17 and the outer body 19 is filled. In both cases, the height h26 of the strip 26 corresponds to the height h26 of the resulting conduit 29. If, in the course of the operation of the rotating body 01, a temperature-regulation medium flows through the conduit 29 which was formed from the removable strip 26, the casting material forms a thermal insulating layer toward the base body 17. This is particularly effective if the conduit 29 has a bottom resting on the base body 17. The temperature-regulation medium is then effective only in the direction facing toward the outer body 19. The base body 17 remains protected against thermal effects. The casting material is thus used as an insulating material. To achieve this insulating effect, a casting material with glass beads scattered in it, which preferably are hollow glass bodies, and in particular are hollow glass spheres, is particularly advantageous. In the same way, it is advantageous to select an insulating material, such as a resin, whose thermal coefficient of expansion corresponds as closely as possible to that of the material of the base body 17 and of the outer body 19 and is therefore matched to it. Advantageously, the outer body 19 and the base body 17 are concentrically aligned with each other in the course of their being assembled.

In the fourth preferred embodiment of the present invention, at least the barrel 02 of the rotating body 01 has a base body 17 with a cylindrical surface 18 and an outer body 19 surrounding the cylindrical surface 18 of the base body 17, as seen in FIGS. 6a and 6b. An interior diameter D19 of the outer body 19 is greater than an exterior diameter D17 of the base body 17. The rotating body 01 is distinguished in that a casting material, which preferably is an insulating material, and in particular is a castable insulating material, is introduced into a space 27 between the cylindrical surface 18 of the base body 17 and the inside 24 of the outer body 19. The casting material, or the insulating material, forms at least one conduit 29 in the space 27. It is advantageous if the interior diameter D19 of the outer body 19 is greater by between 5 mm and 30 mm, and in particular by 20 mm, than the exterior diameter D17 of the base body 17, and if the outer body 19 is concentrically arranged around the base body 17. The conduit 29 preferably can extend helically around the base body 17 in the outer area of the barrel 02. In a manner that is similar to the previous preferred embodiments, a temperature-regulation medium can flow through the conduit 29. It is advantageous, for the preferred use of the rotating body 01, if the outer body 19 is embodied as a steel tube, and if the base body 17 is forged.

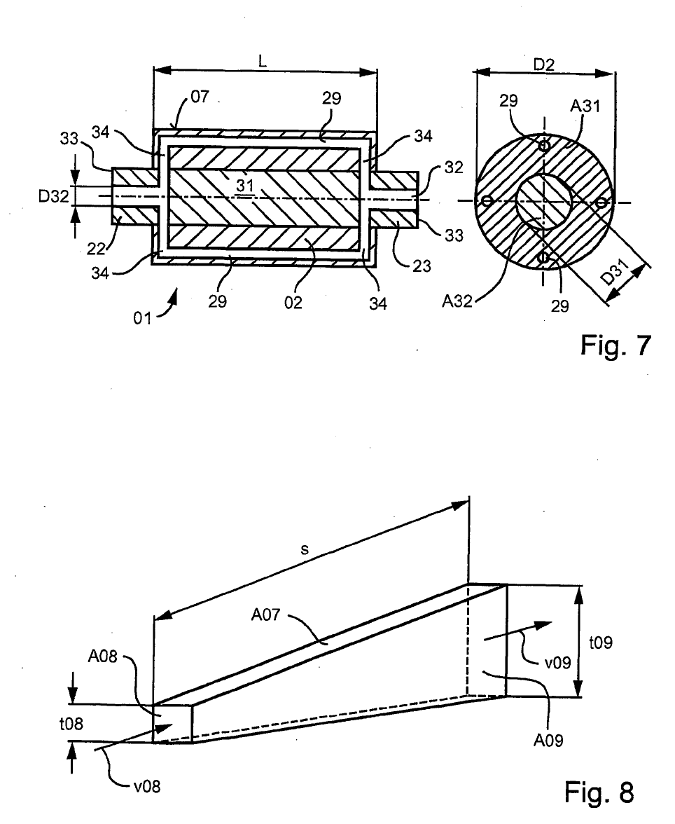

As represented in FIG. 7, a fifth preferred embodiment of the present invention provides a rotating body 01 of a printing press with a barrel 02. A shaft 31 of a diameter D31, which shaft 31 preferably extends through the barrel 02, is arranged centered in the barrel 02. The shaft 31 has a higher resistance to mechanical stress exerted on the rotating body 01, preferably has a higher sturdiness, and in particular has a higher fatigue, a higher breakage resistance or a greater fatigue strength under reversed bending stress, than does the barrel 02. At least one conduit 32, which is leading into the barrel 02, is provided in the shaft 31. The shaft 31 consists, in particular, of a high-strength material, with a corresponding modulus of elasticity, in order to be able to provide in it a conduit 32 of a diameter D32 and with the greatest possible cross-sectional surface A32 in comparison with the cross-sectional surface A31 of the shaft 31 in the interior of the barrel 02, and without impairing the sturdiness properties of the entire rotating body 01, such as the rotating body's fatigue, breakage resistance or fatigue strength under reversed bending stress, for example. The sturdiness properties of the material being used for the barrel 02, such as, for example, an iron-containing casting or an aluminum-containing casting material, are not too great. Accordingly, it would not be possible to utilize a conduit 32, with a large cross-sectional surface A32, for introducing as large as possible a volume flow of a temperature-regulation medium in the hub of the barrel 02 consisting of the same material as the remaining barrel 02, without impairing the sturdiness properties of the rotating body 01. However, the sturdiness of the material should be sufficient to permit the provision of a conduit 32 of a large cross-sectional surface A32. To form the conduit 32 in the shaft 31, an axial bore, with a diameter D32 of between 8 mm and 30 mm can be cut. The diameter D32 of the conduit 32 is approximately 40% of the diameter D31 of the shaft 31. In this way, the cross-sectional surface A32 of the conduit 32 can be approximately 20%, or more, of the cross-sectional surface A31 of the shaft 31. Despite the formation of such a conduit 32 in the shaft 31, the geometric dimensions of the shaft 31 should remain unchanged, in comparison with customary shafts 31. In particular these dimensions should not be increased. Instead, under the same mechanical stress exerted on the rotating body 01, the increased sturdiness of the shaft 31 compensates for its weakening that results because of the conduit 32 cut into it. The conduit 32 is embodied on at least one front or end face 33 of the shaft 31 and extends in the barrel 02, over only, for example, a portion of the length L of the barrel 02. The shaft 31 itself, as a component which is homogeneously configured, with respect to its structure and its material, and is of one piece, advantageously extends over at least the length L of the barrel 02 wherein, as previously mentioned, this length L can be up to 2400 mm. Furthermore, journals 22, 23 for supporting the rotating body 01, and for connecting a drive mechanism to accomplish the rotating movement of the rotating body 01, can be formed at the ends of the shaft 31. A temperature-regulation medium, for use in regulating the temperature of the barrel 02, is introduced in the conduit 32 because a rotary transmission leadthrough, which is not specifically shown, is connected to the shaft 31, or at least to one of its journals 22, 23. To accomplish the temperature regulation of the at least one shell face 07 of the barrel 02, on which shell face 07 at least one dressing can be placed for example, the barrel 02 has at least one conduit 29 extending underneath the shell face 07. The conduit 29 of the barrel 02 is connected with the conduit 32 of the shaft 31 by at least one line which is extending substantially radially with respect to the barrel 02, such as, for example, a radial bore 34, or by the use of an annular groove 37, as represented in FIG. 2. In a preferred embodiment, at least the barrel 02 is made, for example, of a casting material. The conduit 29 of the barrel 02 is, for example, enclosed by the casting material of the barrel 02, or is embodied in accordance with one of the previously described embodiments of the rotating body 01. Therefore, the barrel 02 can consist of gray cast iron, of cast steel or of cast aluminum, while the shaft 31 preferably consists of, for example, alloyed or quenched and drawn steel, and in particular of a high-strength steel with a corresponding modulus of elasticity. The rotating body 01 is thus constructed of two components, preferably of different materials, with different sturdiness properties and with melting points that differ from each other. The shaft 31 is introduced into the barrel 02 with non-positive contact, with material-to-material contact or with positive contact, for example. It is connected with the barrel 02 in such a way that the conduits 29, 32 formed in the barrel 02 and the shaft 31 have a connection which is accessible to the temperature-regulation medium that is flowing through them. To the extent that the stability of the shaft 31 permits, the shaft 31 can be cast into the barrel 02. However, in the preferred embodiment of the present invention, the cast barrel 02 is applied to the shaft 31, in particular, by being shrunk onto it. Further possible joining techniques include gluing the barrel 02 in, or clamping it by integral connection or by the insertion of suitable mechanisms, such as wedges, or a tongue-and groove connection, for example. In a method for producing the rotating body 01, a shaft 31 with a conduit 32 of a large cross-sectional surface A32 is arranged centered in the barrel 02. The shaft 31 has been inserted into a barrel 02 produced by the use of casting technology after it has set. The danger of a thermal deformation of the shaft 31, or at least of thermal stresses in the shaft 31, is avoided, which danger otherwise exists, in particular in connection with slim rotating bodies 01 of a relatively small diameter D2 and a large axial length L in comparison therewith, as previously mentioned. With this method of fabrication, warming, or even heating through and softening of the shaft 31 by the liquefied casting material of the barrel 02 is avoided, since the shaft 31 is not enclosed by the casting material which is liquefied by heat. Instead, the shaft 31 is inserted into the cast barrel 02 after it has set. This method contributes to the production of rotating bodies 01 with a shell face 07, which is to be temperature-regulated, having great dimensional accuracy.

A method for regulating the temperature of at least one barrel 02 of a rotating body 01 of a printing press is provided. At least the barrel 02 has at least one hollow body 03, 04, through which a preferably fluid temperature-regulation medium flows at a constant volume flow, or has a conduit 14, 16, 21, 29 with an inflow 08 and an outflow 09 for the temperature-regulation medium, is provided, in that an amount of heat, which is to be exchanged between the barrel 02 and the temperature-regulation medium. An accommodation of a flow velocity v08, v09 of the temperature-regulation medium, which medium flows in the hollow body 03, 04, or in the conduit 14, 16, 21, 29 over a distance “s” between the inflow 08 and the outflow 09. The distance “s” preferably corresponds to the length L of the barrel 02, but corresponds at least to a length of the area on the shell face 07 of the barrel 02 to be imprinted. A embodiment of the hollow body 03, 04, or conduit 14, 16, 21, 29 for this use is depicted in FIG. 8.

With this method, it is possible to accommodate the flow speed v08, v09 of the temperature-regulation medium by, for example, changing a cross-sectional surface A09 of the hollow body 03, 04, or of the conduit 14, 16, 21, 29, at the outflow 09, with respect to a cross-sectional surface A08 of the hollow body 03, 04, or of the conduit 14, 16, 21, 29, at the inflow 08. The flow speed v08, v09 of the temperature-regulation medium can also be accommodated in that a depth t09 of the hollow body 03, 04, or of the conduit 14, 16, 21, 29, at the outflow 09 can be changed with respect to the depth t08 of the hollow body 03, 04, or of the conduit 14, 16, 21, 29, at the inflow 08. It is provided here, that a contact face A07 of the temperature-regulation medium flowing through the hollow body 03, 04, or through the conduit 14, 16, 21, 29, directed to a shell face 07 is kept constant. By the use of these measures, it is achieved that the heat exchange between the shell face 07 of the barrel 02 and the temperature-regulation medium remains constant. With a temperature-regulation medium which becomes steadily warmer because it cools the contact face A07, the flow speed v09 at the outflow 09 is reduced in comparison with the flow speed v08 at the inflow 08, so that the contact time of the temperature-regulation medium at the contact face A07 is proportionally increased. It is also possible, on the other hand, to maintain the flow speed v08, v09 of the temperature-regulation medium along the distance “s” constant and to change the contact face A07 of the temperature-regulation medium with the shell face 07 of the barrel 02 so that the geometry of the contact face A07, or its distance from the shell face 07 of the barrel 02, is changed.

With this sixth preferred embodiment, the rotating body 01 of a printing press has a barrel 02, wherein, in at least the barrel 02, at least one hollow body 03, 04, or conduit 14, 16, 21, 29, through which a temperature-regulation medium flows, and with an inflow 08 and an outflow 09 for the temperature-regulation medium is provided. An amount of heat, which is to be exchanged between the barrel 02 and the temperature-regulation medium, along the distance “s” between the inflow 08 and the outflow 09 in the hollow body 03, 04, or conduit 14, 16, 21, 29, is maintained constant by an accommodation of a flow velocity v08, v09 of the temperature-regulation medium. In this case, the distance “s” advantageously corresponds to at least the area to be imprinted along the length L of the barrel 02.

As described in connection with the present method, the flow velocity v08, v09 of the temperature-regulation medium can be accommodated so that, for example, a cross-sectional face A09 of the hollow body 03, 04, or of the conduit 14, 16, 21, 29, at the outflow 09 is changed in comparison with a cross-sectional area A08 of the hollow body 03, 04, or of the conduit 14, 16, 21, 29, at the inflow 08. Alternatively, the flow speed v08, v09 of the temperature-regulation medium can be accommodated so that a depth t09 of the hollow body 03, 04, or of the conduit 14, 16, 21, 29, at the outflow 09 is changed with respect to the depth t08 of the hollow body 03, 04, or of the conduit 14, 16, 21, 29, at the inflow 08. With this rotating body 01, a contact face A07, directed toward the shell face 07, of the temperature-regulation medium flowing through the hollow body 03, 04, or the conduit 14, 16, 21, 29, is not changed. The flow speed v08, v09 of the temperature-regulation medium along the distance “s” can also remain constant, and the contact face A07, which the temperature-regulation medium has toward the shell face 07 of the barrel 02, can be changed between the inflow 08 and the outflow 09 in its geometry or in its distance from the shell face 07 of the barrel 02.

This sixth preferred embodiment of the rotating body 01 is particularly suitable for configurations wherein the inflow 08 and the outflow 09 of the temperature-regulation medium are arranged on the same end face 11 of the barrel 02. The effect of this sixth embodiment of the rotating body 01 can be achieved, for example, wherein an insert, which changes the cross section along the distance “s” in a desired manner, is introduced in a hollow body 03, 04, or in the conduit 14, 16, 21, 29, of a constant cross section. This insert can be embodied to be wedge-shaped, for example. If the insert for the hollow body 03, 04, or for the conduit 14, 16, 21, 29, is configured as a solid wedge, such as, for example, as a rod, and in particular as a plastic rod whose cross section is configured in the desired manner, this wedge can be introduced into the hollow body 03, 04, or into the conduit 14, 16, 21, 29, by a material-to-material contact or by a positive connection, such as, for example, by gluing or by the use of a press fit. The insert advantageously consists of an insulating material, preferably a castable insulating material, such as, for example, a synthetic resin, and advantageously one with glass beads, preferably hollow glass spheres, scattered in it. The insert is preferably introduced into the hollow body 03, 04, or into the conduit 14, 16, 21, 29, in a casting process or in an injection molding process, and insulates the temperature-regulation medium against the base body 07 of the barrel 02 because of its thermal damping effect. The use of an insert has the advantage that the hollow body 03, 04, or the conduit 14, 16, 21, 29, in the barrel 02 of the rotating body 01 can be realized by the use of a conventional tube, and in particular by the use of a steel tube, or by drilling or milling. An action regarding the flow behavior of the temperature-regulating medium takes place in a processing step which is separate from the introduction of the hollow body 03, 04, or the conduit 14, 16, 21, 29, into the barrel 02. Moreover, it is possible to provide a thermal insulation of the temperature-regulation medium, with respect to the base body 17, in a simple manner by the use of an insert into the hollow body 03, 04, or into the conduit 14, 16, 21, 29.

While preferred embodiments of a printing press, comprising a roller, in accordance with the present invention have been set forth fully and completely hereinabove, it will be apparent to one of skill in the art that various changes in, for example, the type of printing press in which the roller is used, the source and nature of the temperature-regulation medium and the like could be made without departing form the true spirit and scope of the present invention which is accordingly to be limited only by the following claims.

What is claimed is:

1-58. (canceled)

59. A rotating body of a printing press comprising:
a barrel, said barrel including a cylindrical surface;
an outer body supported by said barrel and having an outside forming a shell face of said barrel, said outer body including at least one curved piece engaging said cylindrical surface of said barrel;
an inner surface of said outer body; and
at least one hollow space in said inner surface and open to said cylindrical surface of said barrel, said at least one hollow space being adapted to have a temperature-regulation medium flow therethrough.

60. The rotating body of claim 59 wherein said at least one curved piece has a central angle of less than 360°.

61. The rotating body of claim 59 further including a plurality of said curved pieces, each of said curved pieces including one of said hollow spaces, a central angle of all of said curved pieces being no greater than 360°.

62. The rotating body of claim 59 wherein there are a plurality of said hollow spaces in said inner surface of said outer body.

63. The rotating body of claim 61 further including a gap in said shell face of said barrel defined by two circumferentially adjacent ones of said plurality of curved pieces, and a clamping channel in said barrel and adapted to hold a dressing on said shell surface, said gap defining a slit-shaped opening to said clamping channel.

64. The rotating body of claim 59 wherein said curved piece is ring-shaped in cross-section and encloses said cylindrical surface of said barrel.

65. A rotating body of a printing press comprising:
a barrel, said barrel including a cylindrical surface;
an outer body supported by said barrel and having an outside forming a shell face of said barrel, said outer body including at least one curved piece engaging said cylindrical surface of said barrel, said at least one curved piece having a central angle of less than 360°;
at least one hollow space in said barrel, said at least one hollow space being covered by said at least one curved piece;
a clamping channel in said barrel and adapted to hold a dressing on said shell face; and
a gap in said shell face and being defined by said at least one curved piece, said gap forming a slit-shaped opening to said clamping channel.

66. The rotating body of claim 65 further including a temperature-regulation medium in said hollow space.

67. The rotating body of claim 65 further including a plurality of said hollow spaces in said barrel.

68. The rotating body of claim 65 wherein said at least one curved piece is concentric with said barrel.

69. The rotating body of claim 65 further including a plurality of said curved pieces arranged circumferentially on said cylindrical surface of said barrel, each of said curved pieces overlying one of a plurality of said hollow spaces, said central angle of said plurality of said curved pieces being not greater than 360°.

70. The rotating body of claim 59 further including at least one dressing on said outer body.

71. The rotating body of claim 59 wherein said outer body is a solid body.

72. The rotating body of claim 59 wherein said outer body has an unchanging radial thickness.

73. The rotating body of claim 59 wherein said outer body is incompressible.

74. The rotating body of claim 59 wherein said outer body and said barrel cylindrical surface are releasably connected.

75. The rotating body of claim 59 wherein said outer body is permanently connected with said cylindrical surface of said barrel.

76. The rotating body of claim 59 wherein said outer body is connected to said cylindrical surface of said barrel in a material-to-material connection.

77. The rotating body of claim 59 wherein said barrel is forged.

78. The rotating body of claim 59 wherein at least said outer body is steel.

79. The rotating body of claim 59 wherein said barrel has an axis of rotation and said at least one hollow space is oriented axially with respect to said barrel.

80. The rotating body of claim 59 wherein said at least one hollow space is non-linear.

81. The rotating body of claim 59 wherein said hollow space is milled.

82. The rotating body of claim 59 further including at least two of said hollow spaces spaced equidistant from each other.

83. The rotating body of claim 59 wherein said rotating body is one of a cylinder and a roller adapted to convey a material to be imprinted.

84. The rotating body of claim 59 wherein said rotating body is one of a forme cylinder, a transfer cylinder, an inking system roller and a dampening system roller.

85. The rotating body of claim 63 wherein said gap has a width of less than 3 mm.

86. The rotating body of claim 59 wherein said temperature-regulation medium is a fluid heat-conducting medium.
